(19) United States
(12) Patent Application Publication
(10) Pub. No.: US 2014/0267798 A1
(43) Pub. Date: Sep. 18, 2014

(54) SYNCHRONISATION SYSTEM

(71) Applicant: Timothy McCarthy, Dunsany (IE)

(72) Inventor: Timothy McCarthy, Dunsany (IE)

(73) Assignee: NATIONAL UNIVERSITY OF IRELAND MAYNOOTH, Maynooth (IE)

(21) Appl. No.: 14/355,423

(22) PCT Filed: Aug. 31, 2012
(86) PCT No.: PCT/EP2012/067008

§ 371 Date: Apr. 30, 2014

(30) Foreign Application Priority Data
Nov. 8, 2011 (IE) S2011/0483

(51) Int. Cl. H04N 5/262; G11B 27/28; G11B 27/11

(52) U.S. Cl. CPC H04N 5/2621; G11B 27/11; G11B 27/28
USPC 348/207.1

(57) ABSTRACT

A synchronisation system for correlating positioning data and video data comprises a synchronisation unit which is arranged to: emit an identifier capable of being imaged by a video camera; store the identifier correlated in time with a trail of positioning data corresponding to sequential locations of the synchronisation unit, and communicate the positioning data and correlated identifier to a processing computer. A processing module is operable to nm on a processing computer and is arranged to analyse a sequence of video data to locate the imaged identifier and to determine a time within the video data at which the identifier is located.

### FIELD OF THE INVENTION

This invention relates to a synchronisation system for correlating positioning data and video data.

### BACKGROUND

Examples of GPS (Global Positioning System) enabled video cameras include ContourGPS, GoBandit and Oregon Scientific's ATC-9k. Once these cameras upload a GPS enhanced video file to a computer, associated software enables a user to simultaneously view a user's GPS trail superimposed on a map e.g. OSM (Open Street Map) or Google Maps, or an altitude profile, for example, as described in U.S. Pat. No. 6,741,790 from RedHen alongside a video display.

However, there are a number of users, typically with high-end legacy cameras which are not GPS enabled who wish to enhance their video with positioning information. Wired systems are available for connecting a GPS device to such cameras and these usually encode the GPS information onto a hidden portion of video e.g. Vertical Line Interval (VLI) or the audio track. These solutions require cables, connectors and encoding/decoding units during data capture as well as data processing. Another shortcoming is that frame-synchronised GPS is usually not guaranteed, leading to inaccuracies in temporal and spatial matching of video frames to real-world events.

It is an object of the present invention to overcome these problems.

### SUMMARY

According to the present invention, there is provided a synchronisation system for correlating positioning data and video data, the system comprising:
a synchronisation unit which is arranged to: emit an identifier capable of being imaged by a video camera; store said identifier correlated in time with a trail of positioning data corresponding to sequential locations of said synchronisation unit; and communicate said positioning data and correlated identifier to a processing computer; and
a processing module operable to run on a processing computer and arranged to analyse a sequence of video data to locate said imaged identifier and to determine a time within said video data at which said identifier is located.

Preferably, said unit is arranged to emit an identifier comprising an optical pattern.

Preferably, said identifier comprises a sequence identifier having a value corresponding with a time for acquiring a respective portion of said positioning data.

Preferably, said identifier further comprises an identifier for said synchronisation unit.

In additional or alternatively, said identifier includes time and date information.

In addition or alternatively, said positional data includes one or more of: orientation data, and pitch-roll-yaw data.

The system is cooperable with application software which is arranged to: spatially map said positioning data trail to a display; and to display said video from a time selected by a user and corresponding to a location from said positioning data trail acquired at said selected time.

Preferably, said application software is responsive to said user selecting said location on said spatial display of said data, to correlate said location with a time from said positioning data trail and to display said video from said time.

If orientation data is available from either the video data or the positioning data trail, camera field of view as distinct from camera XYZ data, can be computed and displayed at each updated position on the spatial display of said positioning data.

Embodiments of the invention include a synchronisation unit that enables a code associated with a GPS trail to be frame-synchronised with an imaging sensor such as in a video camera within a few seconds. Processing software can extract the code automatically from the video stream and link this to the associated GPS trail acquired from the synchronisation unit. Application software allows users to interact with these two streams of data i.e. the video stream and the GPS trail within a combined map and video interface.

Preferably, the application software allows user to tag frames and populate databases with any data contained in an acquired video clip.

By comparison to the prior art, the frame-synchronised solution of embodiments of the present invention enables a high degree of temporal and subsequently spatial accuracy to be achieved.

The LED based array of the embodiment transmits up to 100 bytes of information in a very short burst under variable location, orientation and most natural and man-made illumination conditions

The invention is not linked to any particular model of video camera and enables a user to turn their video camera into a high-grade spatial mapping tool, instantly recording not only picture information but also accurate timing and spatial information.

### BRIEF DESCRIPTION OF THE DRAWINGS

An embodiment of the invention will now be described, by way of example, with reference to the accompanying drawings, in which:

FIG. 1 is a schematic view of the synchronisation system according to an embodiment of the invention;

FIG. 2 shows a sample display for a user interface application according to an embodiment of the invention;

FIG. 3 illustrates a synchronisation and data code transmission sequence produced by a synchronisation unit according to an embodiment of the invention.

### DESCRIPTION OF THE PREFERRED EMBODIMENT

Referring now to FIG. 1, there is shown a synchronisation system according to a preferred embodiment of the present invention. The system operates in conjunction with a conventional video camera 10 which provides a stream of video in any suitable manner to a processing computer 20. Thus, the connection between the camera 10 and computer 20 can be wired, wireless, local to a terminal computer 20 or indeed remote to a server computer 20 with the server computer being connected to the camera 10 by any number of intermediate nodes across a network (not shown). Indeed the video can be provided either after acquisition or streamed directly to the computer while it is being acquired.

Embodiments of the invention rely on the camera 10 having an available clock that time-stamps video with some date/time value. For cameras having an internal clock, the clock should be accurately set by the user and this would then be accessible for later processing by the computer 20.

In any case, video from the camera 10 is stored in a database 30 for subsequent access by processing module(s) running on the computer 20. The database can be as simple as a designated directory within a file storage system accessible to the computer 20; or the video could in fact be stored within say an ODBC compliant database where it can be cross-indexed with any other suitable information including positional data as explained below.

The synchronisation system includes a synchronisation unit 40 and this includes a GPS receiver 42 which when the synchronisation unit is turned on provides a sequence of GPS locations, each acquired at a given time and which are stored by a controller 44 in local memory (not shown) to form a GPS trail.

In the embodiment, the synchronisation unit further comprises a 4×4 array of LEDs 46, which are switched by the controller 44 as explained below.

The unit 40 is contained with a compact hand-held weather-proof housing through or from which the LEDs 46 are visible.

In use, the user turns on the synchronisation unit 40 and the controller 44 indicates to the user with a particular status LED sequence when the GPS Receiver 42 is initialised and the unit is ready. (Indeed the unit could include any suitable indicator to provide this information.)

The controller 42 then causes the LED array 46 to transmit or flash a sequence of synchronising and data frames whilst at the same time logging GPS information, preferably at 1 Hz, and preferably storing this information in NMEA (National Marine Electronics Association) compatible format.

Referring to FIG. 3, in the embodiment, the data frames transmitted by the controller 42 via the LED array 46 comprise a code (Serial-ID) derived from the GPS Receiver serial number followed by a sequence identifier (Seq-ID), an incremental counter value taken from a persistent onboard memory store within the synchronisation unit. Thus, with the 4×4 LED array 46, any synchronisation unit can have a unique serial code value from 0 up to and including 65,535; and the sequence identifier can also have a value from 0 up to and including 65,535.

In the embodiment, each frame of information transmitted by the unit 40 is constructed based on 4 rows of information, each row corresponding to a row of the LED array. Row-1 of the array contains the first number, Row-2 the second and so, on. So, for example, a sequence-ID value of 5,432 corresponds to 1538H. Here, Row-1 of the array would display 1 as OFF, OFF, OFF, ON, Row-2 would display 5 as OFF, ON, OFF, ON, Row-3 would display 3 as OFF, OFF, ON, ON and Row-4 would display 8 as On, OFF, OFF, OFF. Of course any coding scheme could be used to transmit any variety of data via the LED array 46.

In the embodiment, a single synchronisation and data code sequence commences with a synchronisation pattern which is generated on any rollover of a GPS UTC (Coordinated Universal Time) second. This GPS UTC second is tagged in a log file against the appropriate GPS NMEA record with the same Serial-id, in this case 33324 or 822CH, and Sequence-ID, in this case 5432 or 1538H, transmitted via the LED array 46.

The synchronisation pulse is a three frame pattern comprising all LEDs of the array on for 100 ms, followed by an ‘X’ pattern displayed using the LED array and lasting 100 ms followed by all LEDs off for 100 ms. This is followed by the data code frames comprising the serial-ID displayed for 100 ms, all LEDs off for 100 ms, followed by the sequence-ID for 100 ms. A second trailing synchronisation pulse is displayed similar to the leading synchronisation pulse.

The following is a sample showing where the synchronization pulse data code values 33324,5432 are inserted within the GPS log file:
085717.064,5323.2428, N,00636.0025,W,0,03,-55.4,M,55.4,M,000 085718.063,5323.2545, N,00635.9979,W,0,03,-55.4,M,55.4,M,000 33324,5432
085719.063,5323.2656,N,00635.9886,W,0,03,-55.4,M,55.4,M,000 085720.064,5323.2563,N,00635.9923,W,0,03,-55.4,M,55.4,M,000 085721.064,5323.2593,N,00635.9882,W,0,03,-55.4,M,55.4,M,000 085722.063,5323.2655,N,00635.9829,W,0,03,-55.4,M,55.4,M,000 085723.063,5323.2304,N,00636.0080,W,0,03,-55.4,M,55.4,M,000 085724.064,5323.2330,N,00636.0124,W,0,03,-55.4,M,55.4,M,000

In order to use the synchronisation unit 40, the user simply begins recording with the video camera 10 and points the camera at the synchronisation unit for a few seconds while the synchronisation and data frames are being flashed.

Any video camera can be used to record this flash sequence typically from a distance of up to 3 m, independent of orientation and under typical indoor and outdoor illumination conditions. The synchronisation unit can then be attached to the video camera or located nearby so that movement of the unit 40 corresponds with movement of the camera 10. Such a synchronisation event might typically take 2 or 3 seconds and is usually sufficient for a few hours, and as will be seen, multiple video clips can be recorded based on one synchronisation event.

Automated matching between the video clips and a GPS trail can be carried out later as long as the synchronisation unit 40 is co-located with video camera 10 and has been operating for the same duration.

When video recording is completed, the user can download the video data to the computer 20 and the database 30. Separately, the GPS log files can also be downloaded from the synchronisation unit 40 for example via a USB connection, however any suitable connection wired, wireless, local or remote can be employed.

A machine vision decoding module 22 searches the video data within the database 30 for a synchronisation pattern imaged during recording of the video and decodes this. This provides the module 22 with the Serial-ID for the synchronisation unit 40 as well as a Sequence-ID which can be closely correlated with a GPS UTC time stamp. As mentioned, this decoding operation can be carried out, for example, on a stand-alone computer or provided as a web service.

In one embodiment, the module 22 is based on an open source utility ffmpeg, including libraries and programs for handling multimedia data, together with OpenCV. These are used to examine frames of video at 2 Hz to detect the high visibility LED sequence, cycling every 1 second.

Once this pattern is detected, a finer frame-based search is used to detect the synchronisation pattern. The data code pattern is then decoded and the associated frame id and video time code can be retrieved.

A second module 24 uses the decoded data code information from the video to search the appropriate GPS log files within the database table 30 to retrieve the associated GPS trail and to locate the Sequence-ID extracted from the video file within the GPS trail information.

Once time/position from an image frame is synchronised with associated time/position in an uploaded/stored log file, the 1 Hz GPS data code can then be interpolated, both forwards and backwards through the entire video data stream at frame level based on the match between internal video camera time (e.g. 25 Hz for PAL) and GPS UTC 1 Hz time.

An update module 26, can write metadata back to the database 30 indicating navigation trail extent, date, time, camera-GPS date/time offset, user-id as well as a flag indicating that a video clip has been decoded, if accessed at a later point, and indicating where the associated GPS information for the clip can be accessed within the database.

It will be seen that if a user assumes any preceding/subsequent clips from the camera have been acquired with a generally co-located synchronization unit, then the video camera time associated with the clip can be correlated with the GPS UTC time of an associated video trail to provide the GPS information for any clip, even though the synchronization pattern may not have been imaged while recording the preceding/subsequent clip.

The information now stored in the database 30 could for example, be used to export GPS enhanced video in a format compatible with software which processes video from conventional GPS enabled video cameras mentioned above.

Referring to FIG. 2, in one implementation, a dedicated integrated map and video application 28 enables the user to interactively navigate through the correlated video and GPS datastreams with the GPS trail 50 information superimposed on a map window 52 and video stream rendered in a second window 54. A slider control 56 is provided for the video window 54 and progress indicators 58′, 58″ on each of the slider 56 and the GPS trail 50 are synchronized with one another.

Preferably, the application 28 is responsive to the user clicking on the GPS trail 50 to correlate the location on the trail with the GPS UTC time at which the user occupied that location and then to correlate the GPS UTC time with the video time and to determine the corresponding frame of video from which to continue rendering the video. Equally, the application 28 is responsive to the user clicking on the slider 56 to determine the required video time and to correlate this time with the GPS UTC time and thus the location on the trail with that GPS UTC time to update the window display 52 accordingly.

Enhancement to the multimedia-map user-interface include extending the conventional multimedia time-line based control 56 or the trail 50 to include other descriptors or representations of the spatially encoded multimedia trail such as Distance, Altitude, Speed, Acceleration, Tags, Heading.

Variations of the above-described embodiment are possible. For example, the unique serial and or sequence code from the synchronization unit could be extended to include GPS UTC date and time as well as a version number enabling more flexibility in downstream decoding. For example, this would avoid the need to rely on the video camera providing a time stamp as this information could be extracted from a video clip in the same manner as the Serial-ID and Sequence-ID.

The above-described process takes advantage of the highly accurate absolute time base reference of the GPS Receiver 42 as well as the reasonably robust internal time codes and frame sequencing typically available on video cameras. Equally, the process takes advantage of the relatively high temporal frequency of video recording e.g. PAL 25 frames per second (fps) and NTSC 30 fps to transmit a synchronisation pulse followed by a unique data code using a light emitting array which can be accurately synchronised with data from a GPS trail.

While the example shown in FIG. 3 involves synchronisation and data frames extending over a second, the LED array 46 can switch each light element on/off frequencies up to 1 kHz and so, synchronisation and associated data codes can be transmitted in far less than a second if required.

The synchronization unit could also be extended to include a digital compass and/or other sensors as well as orientation e.g. digital compass, or pitch-roll-yaw e.g. from inertial sensors, information.

As indicated, the synchronization unit could be implemented to include a WiFi chipset to enable automated uploading of GPS trail information to a server for processing. In any case, any of the above-described embodiments, data processing can be carried using a stand-alone application or alternatively, can be carried out online at a web server.

In further variations, the synchronisation unit could comprise a smart phone running an application that would display both the Serial-ID and Sequence-ID as a series of flashing symbols. This could be used to encode GPS trace information into other third party cameras that did not have positional recording ability.

Using a smart phone could enable an application instead of displaying symbols to display large alphanumeric characters which could be imaged by a video camera. If these could not be detected with machine vision as described above, the user could still manually find this frame in a video sequence and synchronise the frame manually. This then enables the uploaded GPS trace to be retrieved from the database and interpolated forwards/backwards as described above.

As indicated, where at least camera orientation information is available, the field of view (FOV) of the camera can be displayed in the map window 52. FOV can be automatically computed using interior (focal length, sensor size etc) and exterior orientation (XYZ, pitch, roll, yaw & Digital Elevation Models (DEM)) parameters. This FOV may be planimetric (near vertical) or oblique in terms of recording geometry.

The invention can be implemented to operate in near real-time conditions where an video datastream and GPS trace are transmitted as separate channels but are synchronised and processed moments after reaching the server. The full motion geocoded video stream would be displayed beside a moving map display with a dynamically plotting GPS trace with all tagging/positioning functionality similar to off-line mode.

The invention is not limited to the embodiment(s) described herein but can be amended or modified without departing from the scope of the present invention.

1. A synchronisation system for correlating positioning data and video data, the system comprising:
a synchronisation unit which is arranged to: emit an identifier capable of being imaged by a video camera; store said identifier correlated in time with a trail of positioning data corresponding to sequential locations of said synchronisation unit; and communicate said positioning data and correlated identifier to a processing computer; and
a processing module operable to run on a processing computer and arranged to analyse a sequence of video data to locate said imaged identifier and to determine a time within said video data at which said identifier is located.

2. A synchronisation system according to claim 1 wherein said unit is arranged to emit an identifier comprising an optical pattern.

3. A synchronisation system according to claim 2 wherein said identifier comprises a sequence identifier having a value corresponding with a time for acquiring a respective portion of said positioning data.

4. A synchronisation system according to claim 3 wherein said identifier further comprises an identifier for said synchronisation unit.

5. A synchronisation system according to claim 3 wherein said identifier further comprises time and date information.

6. A synchronisation system according to claim 1 wherein said positioning data includes one or more of: orientation data, and pitch-roll-yaw data.

7. A synchronisation system according to claim 2 wherein said synchronisation unit comprises an LED array arranged to emit said identifier.

8. A synchronisation system according to claim 1 further comprising application software which when executed on a processing computer is arranged to: spatially map said positioning data trail to a display; and to display said video from a time selected by a user and corresponding to a location from said positioning data trail acquired at said selected time.

9. The system according to claim 8 wherein said application software is responsive to said user selecting said location on said spatial display of said data, to correlate said location with a time from said positioning data trail and to display said video from said time.

10. The system according to claim 8 wherein said application software is responsive to orientation data available from either the video data or the positioning data trail, to calculate camera field of view and to display said field of view at each updated position on the spatial display of said positioning data.

11. The system according to claim 8 wherein the application software is arranged to allow a user to tag video frames from said sequence of video data and populate databases with any data contained in an acquired video clip.
